(19) United States
(12) Patent Application Publication
(10) Pub. No.: US 2005/0249940 A1
(43) Pub. Date: Nov. 10, 2005

(54) Fluoropolyether poly(meth)acryl compounds

(75) Inventors: Thomas P. Klun, Lakeland, MN (US); John C. Chang, New Brighton, MN (US); Cheryl L. S. Elsbernd, Woodbury, MN (US); Miguel A. Guerra, Woodbury, MN (US); Naiyong Jing, Woodbury, MN (US); George G. I. Moore, Afton, MN (US); Zai-Ming Qiu, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/121,742

(22) Filed: May 4, 2005

Related U.S. Application Data
(63) Continuation-in-part of application No. 11/026,700, filed on Dec. 30, 2004.
(60) Provisional application No. 60/569,351, filed on May 7, 2004.

(51) Int. Cl. B32B 5/16; B32B 27/00

(52) U.S. Cl. 428/323; 428/421; 428/422

(57) ABSTRACT

Fluoropolyether poly(meth)acryl compounds comprising at least one terminal perfluoropolyether group and at least two groups (meth)acryl groups. A preferred perfluoropolyether group includes F(CF(CF₃)CF₂O)ₐCF(CF₃)— group wherein a averages 1 to 15 and at least two groups (meth)acryl groups.

### CROSS REFERENCE TO RELATED APPLICATIONS

This application claims priority to U.S. Provisional Patent Application No. 60/569,351, filed May 7, 2004, and is a continuation-in-part of U.S. patent application Ser. No. 11/026700, filed Dec. 30, 2004.

### SUMMARY OF THE INVENTION

Fluoropolyether poly(meth)acryl compound are described that comprise at least one terminal perfluoropolyether group, such as F(CF(CF₃)CF₂O)ₐCF(CF₃)— wherein a averages 1 to 15, and at least two groups (meth)acryl groups. In some embodiments, a averages between 3 and 10 or a averages between 5 and 8. The (meth)acryl groups may be independently selected from methacrylate groups and acrylate groups.

In another embodiment, the invention relates to a substrate and a surface layer disposed on the substrate wherein the surface layer comprises at least one of the described fluoropolyether poly(meth)acryl compounds. The surface layer may comprise the reaction product of a polymerizable composition comprising the described fluoropolyether poly(meth)acryl compounds.

In another embodiment, the invention relates to a coating composition comprising the fluoropolyether poly(meth)acryl compound and a diluent such as a solvent, a (meth)acryl monomer, and mixtures thereof. The solvent may include non-fluorinated organic solvents, fluorinated organic solvents, and mixtures thereof.

In another embodiment, the invention relates to a ceramer comprising a binder, inorganic particles, and the fluoropolyether poly(meth)acryl compound.

The amount of fluoropolyether poly(meth)acryl compound in the surface layer, coating, or ceramer may range from 0.05 wt-% to 15 wt-%.

The dried and optionally cured surface layer exhibits ink repellency and is preferably durable.

### DETAILED DESCRIPTION OF THE PREFERRED EMBODIMENTS

The present invention describes compounds having at least one fluoropolyether group and at least two (meth)acryl groups.

The fluoropolyether group preferably comprises perfluorinated propylene oxide repeat units. More preferably, the compound comprises at least one terminal F(CF(CF₃)CF₂O)ₐCF(CF₃)— group wherein “a” averages at least about 3 (e.g. 4, 5). Further, “a” typically averages no more than 15 (e.g. 14, 13, 12, 11, 10, 9, or 8). In some aspects, “a” averages 6 to 7. Unless stated otherwise, as used in the detailed description, “HFPO-” refers to the end group wherein a averages about 3 to 15.

The compound of the invention comprises at least two (meth)acryl groups. The (meth)acryl groups are preferably (meth)acrylate groups optionally substituted with hydrogen and/or fluorine. In at least some embodiments, the (meth)acryl groups are preferably acrylate groups.

The fluoropolyether poly(meth)acryl compounds described herein may have the formula (R_{fpe})ₙQ(X)ₘ wherein:

R_{fpe} is the residue of a monovalent HFPO moiety of the formula F(CF(CF₃)CF₂O)ₐCF(CF₃)— wherein a is 3 to 15 and n is 1 to 3;
Q is a connecting group of valency at least 2 and is selected from the group consisting of a covalent bond, an alkylene, an arylene, an aralkylene, an alkarylene, a straight or branched chain or cycle-containing connecting group optionally containing heteroatoms O, N, and S and optionally a heteroatom-containing functional group such as carbonyl or sulfonyl, and combinations thereof;
X is a (meth)acryl functional group-AC(O)C(R)=CH₂, wherein A is O, S or NR₁, R is a lower alkyl of 1 to 4 carbon atoms or H or F, R₁ is H or lower alkyl of 1 to 4 carbon atoms, and m is 2-10.

Exemplary compounds include for example:
a) HFPO—C(O)NHC(CH₂OC(O)CH═CH₂)₃
b) HFPO—C(O)N(CH₂CH₂OC(O)CH═CH₂)₂
c) HFPO—C(O)NHCH₂CH₂N(C(O)CH═CH₂)CH₂OC(O)CH═CH₂
d) HFPO—C(O)NHC(CH₂OC(O)CH═CH₂)₂H
e) HFPO—C(O)NHC(CH₂OC(O)CH═CH₂)₂CH₃
f) HFPO—C(O)NHC(CH₂OC(O)CH═CH₂)₂CH₂CH₃
g) HFPO—C(O)NHCH₂CH(OC(O)CH═CH₂)CH₂OC(O)CH═CH₂
h) HFPO—C(O)NHCH₂CH₂CH₂N(CH₂CH₂OC(O)CH═CH₂)₂
i) HFPO—C(O)OCH₂C(CH₂OC(O)CH═CH₂)₃
j) HFPO—C(O)NH(CH₂CH₂N(C(O)CH═CH₂))₄CH₂CH₂NC(O)—HFPO
k) CH₂═CHC(O)OCH₂CH(OC(O)HFPO)CH₂OCH₂CH(OH)CH₂OCH₂CH(OC(O)HFPO)CH ₂OCOCH═CH₂; and
l) HFPO—CH₂O—CH₂CH(OC(O)CH═CH₂)CH₂OC(O)CH═CH₂

The fluoropolyether poly(meth)acryl compounds described herein may have the formula B—O(CH₂CH(OB)CH₂O)ₙCH₂CH(OB)CH₂O—B wherein n ranges from 0 to 20, and B is independently H, —C(O)CH═CH₂, or —C(O)—HFPO, and in which at least one B is —C(O)—HFPO and at least two B's are —C(O)CH═CH₂.

An exemplary compound of this type is CH₂═CHC(O)OCH₂CH(OC(O)HFPO)CH₂OCH₂CH(OH)CH₂OCH₂CH(OC(O)HFPO)CH ₂OC(O)CH═CH₂.

The fluoropolyether poly(meth)acryl compounds may be the reaction product of either of the following Reaction Sequences A and B: 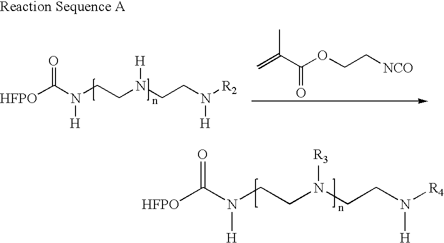 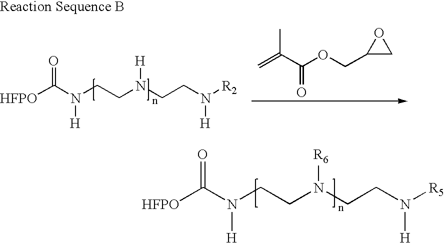
In each of Reaction Sequences A and B, R₂ is hydrogen, alkyl, aryl, arylalkyl, alkylaryl, fluoroalkyl, acryl, HFPO—C(O)—, R₃ is independently H or CH₂═C(CH₃)C(O)—OC₂H₄NHC(O)—, R₄ is alkyl, aryl, arylalkyl, alkylaryl, fluoroalkyl, acryl, HFPO—C(O)—, or CH₂═C(CH₃)C(O)—OC₂H₄NHC(O)—, R₅ is alkyl, aryl, arylalkyl, alkylaryl, fluoroalkyl, acryl, HFPO—C(O)—, or CH₂═C(CH₃)C(O)—OCH₂CH(OH)CH₂—, R₆ is independently H or CH₂═C(CH₃)C(O)—OCH₂CH(OH)CH₂—, and n ranges from an average about 2 to 32.

The fluoropolyether poly(meth)acryl compounds described herein can be prepared in a two step process. The first step is by reaction of poly(hexafluoropropylene oxide) esters, such as HFPO—C(O)OCH₃ or acid halides HFPO—C(O)F, with materials containing at least 3 alcohol or primary or secondary amino groups to produce HFPO— amide polyols or polyamines, HFPO— ester polyols or polyamines, or HFPO— amides, or HFPO— esters with mixed amine and alcohol groups. The second step is the (meth)acrylation of the alcohol and/or amine groups with (meth)acryloyl halides, (meth)acrylic anhydrides or (meth)acrylic acid. Exemplary syntheses thereof are set forth in the examples.

The fluoropolyether poly(meth)acryl compounds can be employed as a surface layer on a variety of articles in order to impart low surface energy properties.

The surface energy can be characterized by various methods such as contact angle and ink repellency, as determined according to the test methods described in the examples. The surface layer and articles described herein preferably exhibits a static contact angle with water of at least 70°. More preferably the contact angle with water is at least 80° and even more preferably at least 90° (e.g. at least 95°, at least 100°). Alternatively or in addition thereto, the advancing contact angle with hexadecane is at least 50° and more preferably at least 600. Low surface energy is indicative of anti-soiling properties as well as the surface being easy to clean. As yet another indication of low surface energy, ink from a marker commercially available under the trade designation “Sanford Sharpie, Fine Point permanent marker, no 30001” preferably beads up. Further, the surface layer and articles described herein exhibit “ink repellency”, meaning that the ink can easily be removed by wiping with a tissue commercially available from Kimberly Clark Corporation, Roswell, Ga. under the trade designation “SURPASS FACIAL TISSUE”.

As used herein, wt-% refers to wt-% solids unless indicated otherwise such as in the case of non-polymerizable diluent.

The fluorochemical surface layer comprises at least one of the fluoropolyether poly(meth)acryl compounds described herein, optionally in combination with other polymerizable ingredients (e.g. (meth)acryl monomers and/or crosslinkers) and/or a solvent. The total amount of fluoropolyether poly(meth)acryl compound in the coating composition that is polymerized to form the surface layer is typically at least 0.05 wt-% solids (e.g. at least about 0.10 wt-%, 0.50 wt-%, 1 wt-%, 2 wt-%, 3 wt-%, and 4 wt-%). In some embodiments, the coating composition comprises at least about 5 wt-% solids fluoropolyether poly(meth)acryl compounds. In other embodiments, such as when the fluoropolyether poly(meth)acryl compound of the invention is added to a hardcoat, the hardcoat composition may contain as little as 0.1 wt-% or lower amounts of the fluoropolyether poly(meth)acryl compound(s).

The coating composition may contain as much as 95 wt-% solids of one or more of the described fluoropolyether poly(meth)acryl compounds. It is generally more cost effective to employ a minimal concentration of fluorinated compound that provide the desired low surface energy. Accordingly, the total amount of fluoropolyether poly(meth)acryl compound(s) provided in the coating composition typically does not exceed 30 wt-% and usually is present is an amount of no more than about 15 wt-% (e.g. less than about 14 wt-%, 13 wt-%, 12 wt-%, and 11 wt-%).

In some aspects, the reaction product of a polymerizable composition comprising the fluoropolyther poly(meth)acryl compounds of the invention can be employed as a surface layer optionally above an underlying hardcoat layer, such as described in for example Liu et al., U.S. Pat. No. 6,660,389. The polymerizable composition typically further comprise one or more (e.g. non-fluorinated) (meth)acryl monomers, (meth)acryl oligomers, or (meth)acryl polymers. In order to improve the durability of the surface layer, the reaction product may further comprise at least one crosslinking agent. “Crosslinking agent” and “crosslinker” are used herein interchangeably and refer to a monomer or oligomer having at least two (meth)acryl groups. Preferably, the crosslinker comprises at least two (meth)acrylate groups and thus is a poly(meth)acrylate compound. In at least some embodiments, acrylate groups are preferred.

Although fluorinated crosslinkers can be employed, it is generally more cost effective to utilize non-fluorinated crosslinking agents. As little as 5 wt-% crosslinker can result in suitable durability for some applications. However, it is typical to maximize the concentration of crosslinker particularly since non-fluorinated (meth)acrylate crosslinkers are generally less expensive than fluorinated compounds. Accordingly, the coating compositions described herein typically comprise at least 20 wt-% crosslinking agent(s). The total amount of crosslinking agent(s) may comprise at least 50 wt-% and may be for example at least 60 wt-%, at least 70 wt-%, at least 80 wt-%, at least 90 wt-% and even about 95 wt-% or greater of the coating composition.

Useful crosslinking agents include, for example, poly(meth)acryl monomers selected from the group consisting of (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing; and combinations thereof. Such compounds are widely available from vendors such as, for example, Sartomer Company, Exton, Pa.; UCB Chemicals Corporation, Smyrna, Ga.; and Aldrich Chemical Company, Milwaukee, Wis. Additional useful (meth)acrylate materials include hydantoin moiety-containing poly(meth)acrylates, for example, as described in U.S. Pat. No. 4,262,072 (Wendling et al.).

A preferred crosslinking agent comprises at least three (meth)acrylate functional groups. Commercially available crosslinking agent include those available from Sartomer Company, Exton, Pa. such as trimethylolpropane triacrylate available under the trade designation “SR351”, pentaerythritol triacrylate available under the trade designation “SR444”, dipentaerythritol pentaacrylate available under the trade designation “SR399LV”, ethoxylated (3) trimethylolpropane triacrylate available under the trade designation “SR454”, and ethoxylated (4) pentaerythritol triacrylate, available under the trade designation “SR494”.

The coating composition described herein may comprise various combinations of one or more of the (per)fluoropolyether poly(meth)acryl compound of the invention. Further, the inventive compounds may be employed in combination with other known monofunctional (per)fluoropolyether compound(s) and polyfunctional (per)fluoropolyether compounds.

Alternatively or in addition thereto, the coating composition described herein may further various other reactive and non-reactive ingredients. For example the composition may comprise polymerizable (meth)acryl compounds with alkyl, perfluoroalkyl, and perfluoroalkylene moieties. Examples of these compounds include butyl acrylate, 1H,1H-2,2,3,3,4,4,4-heptafluorobutyl acrylate, available from Sigma-Aldrich; 1H,1H,2H,2H-perfluorodecyl acrylate, available from Lancaster Synthesis, Windham, N.H.; and C₄F₉SO₂N(CH₃)CH₂CH₂OC(O)CH═CH₂ made by the procedure of Examples 2A and 2B of WO01/30873A. Other (meth)acryl compounds with perfluoroalkyl moieties are mentioned in U.S. Pat. No. 4,968,116 and in U.S. Pat. No. 5,239,026 (including (perfluorocyclohexyl)methyl acrylate).

To facilitate curing, polymerizable compositions according to the present invention may further comprise at least one free-radical thermal initiator and/or photoinitiator. Typically, if such an initiator and/or photoinitiator are present, it comprises less than about 10 percent by weight, more typically less than about 5 percent of the polymerizable composition, based on the total weight of the polymerizable composition. Free-radical curing techniques are well known in the art and include, for example, thermal curing methods as well as radiation curing methods such as electron beam or ultraviolet radiation. Further details concerning free radical thermal and photopolymerization techniques may be found in, for example, U.S. Pat. Nos. 4,654,233 (Grant et al.); 4,855,184 (Klun et al.); and 6,224,949 (Wright et al.).

Useful free-radical thermal initiators include, for example, azo, peroxide, persulfate, and redox initiators, and combinations thereof.

Useful free-radical photoinitiators include, for example, those known as useful in the UV cure of acrylate polymers. Such initiators include benzophenone and its derivatives; benzoin, alpha-methylbenzoin, alpha-phenylbenzoin, alpha-allylbenzoin, alpha-benzylbenzoin; benzoin ethers such as benzil dimethyl ketal (commercially available under the trade designation “IRGACURE 651” from Ciba Specialty Chemicals Corporation of Tarrytown, N.Y.), benzoin methyl ether, benzoin ethyl ether, benzoin n-butyl ether; acetophenone and its derivatives such as 2-hydroxy-2-methyl-1-phenyl-1-propanone (commercially available under the trade designation “DAROCUR 1173” from Ciba Specialty Chemicals Corporation) and 1-hydroxycyclohexyl phenyl ketone (commercially available under the trade designation “IRGACURE 184”, also from Ciba Specialty Chemicals Corporation); 2-methyl-1-[4-(methylthio)phenyl]-2-(4-morpholinyl)-1-propanone commercially available under the trade designation “IRGACURE 907”, also from Ciba Specialty Chemicals Corporation); 2-benzyl-2-(dimethylamino)-1-[4-(4-morpholinyl)phenyl]-1-butanone commercially available under the trade designation “IRGACURE 369” from Ciba Specialty Chemicals Corporation); aromatic ketones such as benzophenone and its derivatives and anthraquinone and its derivatives; onium salts such as diazonium salts, iodonium salts, sulfonium salts; titanium complexes such as, for example, that which is commercially available under the trade designation “CGI 784 DC”, also from Ciba Specialty Chemicals Corporation); halomethylnitrobenzenes; and mono- and bis-acylphosphines such as those available from Ciba Specialty Chemicals Corporation under the trade designations “IRGACURE 1700”, “IRGACURE 1800”, “IRGACURE 1850”,“IRGACURE 819” “IRGACURE 2005”, “IRGACURE 2010”, “IRGACURE 2020” and “DAROCUR 4265”. Combinations of two or more photoinitiators may be used. Further, sensitizers such as 2-isopropyl thioxanthone, commercially available from First Chemical Corporation, Pascagoula, Miss., may be used in conjunction with photoinitiator(s) such as ““IRGACURE 369”.

The coating compositions can contain other optional adjuvants, such as, surfactants, antistatic agents (e.g., conductive polymers), leveling agents, photosensitizers, ultraviolet (“UV”) absorbers, stabilizers, antioxidants, lubricants, pigments, dyes, plasticizers, suspending agents and the like.

The compositions described herein can provide a synergistic combination of low surface energy as imparted by the (per)fluoropolyether (meth)acryl compound in combination with good durability, as imparted by the hydrocarbon crosslinking agent. The composition described herein is typically free of hydrophilic ingredients (e.g. monomers) since the inclusion of such tends to reduce anti-soiling properties as well as stain certain media (e.g. substrates). Hydrophilic components are also susceptible to degradation upon exposure to aqueous based cleaning agents.

The surface layer and articles described herein are also preferably durable, meaning that the surface exhibits substantially no surface damage or significant loss of optical properties (e.g. retains 97% of its original transmission) after durability testing conducted according to the test method described in the examples wherein cheesecloth is employed with a 725 g weight and 200 wipes. Further, the surface layer and articles preferably continues to exhibit the previously described low surface energy properties (e.g. contact angles, ink repellency, and bead up) even after such durability testing.

The presently described surface layer does not detract from the optical qualities of the article (e.g. display). Accordingly, the articles of the invention exhibit substantially the same initial haze and transmission values in comparison to the same substrate or hardcoat coated substrate lacking such surface layer as described herein. Preferably the haze and transmission values are substantially the same after durability testing.

The coating composition of the invention can be applied as a separate surface layer using a diluent that assists in coating of the composition. Those skilled in the art will appreciate that selection of a desired diluent and diluent level will depend on the substrate or surface being coated, the ingredients of the coating composition, and on the coating conditions. Although fluorinated solvents could optionally be employed alone or in combination with an organic solvent, the (per)fluoropolyether acrylate(s) and crosslinking agent are generally sufficiently soluble in non-fluorinated solvent. Thus, the coating composition can advantageously be free of fluorinated solvents. Solvents include ketones such as methyl ethyl ketone (MEK), methyl isobutylene ketone (MIBK), and methyl propyl ketone (MPK); and acetates such as ethyl acetate, at a concentration to obtain the intended coating thickness (e.g. 2% to 3% solids). Any adjuvants, as previously described, are typically added after dissolution with the solvent.

Alternatively, 100% solids composition can be made by use of one or more (meth)acryl monomers as a diluent.

The coating composition can be applied to a substrate or hardcoat layer disposed on a substrate using a variety of conventional coating methods. Suitable coating methods include, for example, spin coating, knife coating, die coating, wire coating, flood coating, padding, spraying, roll coating, dipping, brushing, foam application, and the like. The coating is dried, typically using a forced air oven. The dried coating is at least partially and typically completely cured using an energy source.

Energy sources include ultraviolet light curing devices that provide a UV “C” dosage of about 5 to 60 millijoules per square centimeter (mJ/cm²). Curing takes place in an environment containing low amounts of oxygen, e.g., less than about 100 parts per million. Nitrogen gas is a suitable environment.

The coating composition is applied at a sufficient amount to provide a cured layer having a thickness of at least about 10 nanometers, and typically at least about 25 nanometers. The cured layer may have a thickness of less than about 200 nanometers, less than about 100 nanometers, or less than about 75 nanometers. In such embodiments, the bulk of the durability may be provided by an underlying hardcoat layer.

As an alternative to providing the coating of the invention as a surface layer on an article or surface such as could be done during the manufacture of the display panel, the coating composition of the invention may be employed as a (e.g. surface) layer on a protective article. For example, such protective articles are described in U.S. Pat. No. 6,660,389; incorporated herein by reference.

Various permanent and removable grade adhesive compositions may be coated on the opposite side of the substrate of the protective article (i.e. to that of the hardcoat) so the article can be easily mounted to a display surface. Suitable adhesive compositions include (e.g. hydrogenated) block copolymers such as those commercially available from Kraton Polymers, Westhollow, Tex. under the trade designation “Kraton G-1657”, as well as other (e.g. similar) thermoplastic rubbers. Other exemplary adhesives include acrylic-based, urethane-based, silicone-based and epoxy-based adhesives. Preferred adhesives are of sufficient optical quality and light stability such that the adhesive does not yellow with time or upon weather exposure so as to degrade the viewing quality of the optical display. The adhesive can be applied using a variety of known coating techniques such as transfer coating, knife coating, spin coating, die coating and the like. Exemplary adhesive are described in U.S. Patent Application Publication No. 2003/0012936. Several of such adhesives are commercially available from 3M Company, St. Paul, Minn. under the trade designations 8141, 8142, and 8161.

A variety of substrates can be utilized in the articles of the invention. Suitable substrate materials include glass as well as thermosetting or thermoplastic polymers such as polycarbonate, poly(meth)acrylate (e.g., polymethyl methacrylate or “PMMA”), polyolefins (e.g., polypropylene or “PP”), polyurethane, polyesters (e.g., polyethylene terephthalate or “PET”), polyamides, polyimides, phenolic resins, cellulose diacetate, cellulose triacetate, polystyrene, styrene-acrylonitrile copolymers, epoxies, and the like. Typically the substrate will be chosen based in part on the desired optical and mechanical properties for the intended use. Such mechanical properties typically will include flexibility, dimensional stability and impact resistance. The substrate thickness typically also will depend on the intended use. For most applications, substrate thicknesses of less than about 0.5 mm are typical, and more typically the thickness ranges from about 0.02 mm to about 0.2 mm. Self-supporting polymeric films are preferred. Films made from polyesters such as PET or polyolefins such as PP (polypropylene), PE (polyethylene) and PVC (polyvinyl chloride) are particularly preferred. The polymeric material can be formed into a film using conventional filmmaking techniques such as by extrusion and optional uniaxial or biaxial orientation of the extruded film. The substrate can be treated to improve adhesion between the substrate and the hardcoat layer, e.g., chemical treatment, corona treatment such as air or nitrogen corona, plasma, flame, or actinic radiation. If desired, an optional tie layer or primer can be applied to the substrate and/or hardcoat layer to increase the interlayer adhesion.

In the case of articles such as display panels and protective articles, the substrate is light transmissive, meaning light can be transmitted through the substrate such that the display can be viewed. Both transparent (e.g. gloss) and matte light transmissive substrates are employed in display panels. Matte substrates typically have lower transmission and higher haze values than typical gloss films. The matte films exhibit this property typically due to the presence of micron size dispersed inorganic fillers such as silica that diffuse light. Exemplary matte films are commercially available from U.S.A. Kimoto Tech, Cedartown, Ga. under the trade designation “N4D2A”. In case of transparent substrates, hardcoat coated transparent substrates, as well as the display articles comprised of transparent substrates, the haze value is preferably less than 5%, more preferably less than 2% and even more preferably less than 1%. Alternatively or in addition thereto, the transmission is preferably greater than about 90%.

A variety of inorganic oxide particles can be used in the hardcoat. The particles are typically substantially spherical in shape and relatively uniform in size. The particles can have a substantially monodisperse size distribution or a polymodal distribution obtained by blending two or more substantially monodisperse distributions. The inorganic oxide particles are typically non-aggregated (substantially discrete), as aggregation can result in precipitation of the inorganic oxide particles or gelation of the hardcoat. The inorganic oxide particles are typically colloidal in size, having an average particle diameter of about 0.001 to about 0.2 micrometers, less than about 0.05 micrometers, and less than about 0.03 micrometers. These size ranges facilitate dispersion of the inorganic oxide particles into the binder resin and provide ceramers with desirable surface properties and optical clarity. The average particle size of the inorganic oxide particles can be measured using transmission electron microscopy to count the number of inorganic oxide particles of a given diameter. Inorganic oxide particles include colloidal silica, colloidal titania, colloidal alumina, colloidal zirconia, colloidal vanadia, colloidal chromia, colloidal iron oxide, colloidal antimony oxide, colloidal tin oxide, and mixtures thereof. The inorganic oxide particles can consist essentially of or consist of a single oxide such as silica, or can comprise a combination of oxides, such as silica and aluminum oxide, or a core of an oxide of one type (or a core of a material other than a metal oxide) on which is deposited an oxide of another type. Silica is a common inorganic particle. The inorganic oxide particles are often provided in the form of a sol containing a colloidal dispersion of inorganic oxide particles in liquid media. The sol can be prepared using a variety of techniques and in a variety of forms including hydrosols (where water serves as the liquid medium), organosols (where organic liquids so serve), and mixed sols (where the liquid medium contains both water and an organic liquid), e.g., as described in U.S. Pat. Nos. 5,648,407 (Goetz et al.); 5,677,050 (Bilkadi et al.) and 6,299,799 (Craig et al.), the disclosure of which is incorporated by reference herein. Aqueous sols (e.g. of amorphous silica) can be employed. Sols generally contain at least 2 wt-%, at least 10 wt-%, at least 15 wt-%, at least 25 wt-%, and often at least 35 wt-% colloidal inorganic oxide particles based on the total weight of the sol. The amount of colloidal inorganic oxide particle is typically no more than 50 wt-% (e.g. 45 wt-%). The surface of the inorganic particles can be “acrylate functionalized” as described in Bilkadi et al. The sols can also be matched to the pH of the binder, and can contain counterions or water-soluble compounds (e.g., sodium aluminate), all as described in Kang et al. '798.

The hardcoat can conveniently be prepared by mixing an aqueous sol of inorganic oxide particles with a free-radically curable binder precursor (e.g., one or more free-radically curable monomers, oligomers or polymers that can participate in a crosslinking reaction upon exposure to a suitable source of curing energy). The resulting composition usually is dried before it is applied, in order to remove substantially all of the water. This drying step is sometimes referred to as “stripping”. An organic solvent can be added to the resulting ceramer composition before it is applied, in order to impart improved viscosity characteristics and assist in coating the ceramer composition onto the substrate. After coating, the ceramer composition can be dried to remove any added solvent, and then can be at least partially hardened by exposing the dried composition to a suitable source of energy in order to bring about at least partial cure of the free-radically curable binder precursor.

A variety of binders can be employed in the hardcoat. The binder is derived from a free-radically polymerizable precursor that can be photocured once the hardcoat composition has been coated upon the substrate. Binder precursors such as the protic group-substituted esters or amides of an acrylic acid described in '799, or the ethylenically-unsaturated monomers described in '799 et al., are often preferred. Suitable binder precursors include polyacrylic acid or polymethacrylic acid esters of polyhydric alcohols, such as diacrylate or di(meth)acrylate esters of diols including ethyleneglycol, triethyleneglycol, 2,2-dimethyl-1,3-propanediol, 1,3-cyclopentanediol, 1-ethoxy-2,3-propanediol, 2-methyl-2,4-pentanediol, 1,4-cyclohexanediol, 1,6-hexamethylenediol, 1,2-cyclohexanediol, 1,6-cyclohexanedimethanol, resorcinol, pyrocatechol, bisphenol A, and bis(2-hydroxyethyl) phthalate; triacrylic acid or trimethacrylic acid esters of triols including glycerin, 1,2,3-propanetrimethanol, 1,2,4-butanetriol, 1,2,5-pentanetriol, 1,3,6,-hexanetriol, 1,5,10-decanetriol, pyrogallol, phloroglucinol, and 2-phenyl-2,2-methylolethanol; tetraacrylic acid or tetramethacrylic acid esters of tetraols including 1,2,3,4-butanetetrol, 1,1,2,2,-tetramethylolethane, 1,1,3,3,-tetramethylolpropane, and pentaerythritol tetraacrylate; pentaacrylic acid or pentamethacrylic acid esters of pentols including adonitol; hexaacrylic acid or hexamethacrylic acid esters of hexanols including sorbitol, dipentaerythritol, dihydroxy ethyl hydantoin; and mixtures thereof. The binder can also be derived from one or more monofunctional monomers as described in Kang et al. '798. The binder comprises one or more N,N-disubstituted acrylamide and or N-substituted-N-vinyl-amide monomers as described in Bilkadi et al. The hardcoat may be derived from a ceramer composition containing about 20 to about 80% ethylenically unsaturated monomers and about 5 to about 40% N,N-disubstituted acrylamide monomer or N-substituted-N-vinyl-amide monomer, based on the total weight of the solids in the ceramer composition.

The inorganic particles, binder and any other ingredients in the hardcoat are chosen so that the cured hardcoat has a refractive index close to that of the substrate. This can help reduce the likelihood of Moire patterns or other visible interference fringes.

As mentioned above, the hardcoat can be formed from an aqueous coating composition that is stripped to remove water prior to coating, and optionally diluted with a solvent to assist in coating the composition. Those skilled in the art will appreciate that selection of a desired solvent and solvent level will depend on the nature of the individual ingredients in the hardcoat and on the desired substrate and coating conditions. Kang et al. '798 describes several useful solvents, solvent levels and coating viscosities.

The hardcoat can be crosslinked with various agents to increase the internal cohesive strength or durability of the hardcoat. Typical crosslinking agents have a relatively large number of available functional groups, and include tri and tetra-acrylates, such as pentaerythritol triacrylate and pentaerythritol tetraacrylate. When used, the crosslinking agent is often less than about 60 parts, such as about 30 to about 50 parts by weight per 100 parts by weight of the binder.

If the hardcoat is prepared by combining an aqueous sol of colloidal inorganic oxide particles with the binder precursor, then the sol has a pH such that the particles have a negative surface charge. For example, if the inorganic particles are predominantly silica particles, the sol is alkaline with a pH greater than 7, greater than 8, or greater than 9. The sol may include ammonium hydroxide or the like so that NH⁺₄ is available as a counter cation for particles having a negative surface charge. If surface treatment of the colloidal inorganic oxide particles is desired, a suitable surface treatment agent can be blended into the sol, e.g., as described in Kang et al. '833, the disclosure of which is incorporated by reference herein. The free-radically curable binder precursor is then added to the ceramer composition. The ceramer composition is stripped to remove substantially all of the water. For example, removing about 98% of the water, thus leaving about 2% water in the ceramer composition, has been found to be suitable. As soon as substantially all of the water is removed, an organic solvent of the type described in Kang et al. '798 is typically added in an amount such that the ceramer composition includes from about 5% to about 99% by weight solids (about 10 to about 70%).

The ceramer composition is coated at a coating weight sufficient to provide a cured hardcoat with a thickness of about 1 to about 100 micrometers, about 2 to about 50 micrometers, or about 3 to about 30 micrometers. After coating, the solvent, if any, is flashed off with heat, vacuum, and/or the like. The coated ceramer composition is then cured by irradiation with a suitable form of energy, such as heat energy, visible light, ultraviolet light or electron beam radiation. Irradiating with ultraviolet light in ambient conditions is often utilized due to the relative low cost and high speed of this curing technique. In addition, the hardcoat surface optionally is roughened or textured to provide a matte surface. This can be accomplished in a variety of ways that will be familiar to those skilled in the art, including embossing the hardcoat with a suitable tool that has been bead-blasted or otherwise roughened, by adding a suitable small particle filler such as silica sand or glass beads to the hardcoat, or by carrying out cure against a suitable roughened master as described in U.S. Pat. Nos. 5,175,030 (Lu et al.) and 5,183,597 (Lu).

The coating composition, reaction product thereof (i.e. cured coating composition) as well as the protective articles of the inventions can be used on a variety of display and protective articles wherein a combination of low surface energy (e.g. anti-soiling, stain resistance, oil and/or water repellency) and durability (e.g. abrasion resistance) is desired while also maintaining optical clarity.

Various illuminated and non-illuminated display panels are known. Such displays include multi-character and especially multi-character, multi-line displays such as liquid crystal displays (“LCDs”), plasma displays, front and rear projection displays, cathode ray tubes (“CRTs”), signage, as well as single-character or binary displays such as light emitting diodes (“LEDs”), signal lamps and switches. The light transmissive (i.e. exposed) substrate of such display panels may be referred to as a “lens”. The invention is particularly useful for displays having a viewing surface that is susceptible to damage during normal use.

The coating composition, reaction product thereof (i.e. dried and cured coating composition) as well as the protective articles of the invention can be employed in a variety of portable and non-portable information display devices including PDAs, cell phones (including combination PDA/cell phones), touch-sensitive screens, wrist watches, car navigation systems, global positioning systems, depth finders, calculators, electronic books, CD or DVD players, projection television screens, computer monitors, notebook computer displays, instrument gauges, instrument panel covers, signage such as graphic displays (including indoor and outdoor graphics, and the like), and the like. These devices can have planar viewing faces, or non-planar viewing faces such as the slightly curved face of a typical CRT. Typically the display element is located on or in close physical proximity to a viewing face of the information display device rather than being spaced an appreciable distance therefrom.

The coating composition, reaction product, and protective article can be employed on a variety of other articles as well such as for example camera lenses, eyeglass lenses, binocular lenses, retroreflective sheeting, raised pavement makers (lenses,) automobile windows, building windows, train windows, boat windows, aircraft windows, vehicle headlamps and taillights, display cases, eyeglasses, watercraft hulls, road pavement markings, overhead projectors, stereo cabinet doors, stereo covers, furniture, floor finishes, bus station plastic, watch covers, as well as optical and magneto-optical recording disks, and the like.

Objects and advantages of this invention are further illustrated by the following examples, but the particular materials and amounts thereof recited in these examples, as well as other conditions and details, should not be construed to unduly limit this invention.

### EXAMPLES

Test Methods

1. Contact Angle—The coatings were rinsed for 1 minute by hand agitation in IPA before being subjected to measurement of water and hexadecane contact angles. Measurements were made using as-received reagent-grade hexadecane (Aldrich) and deionized water filtered through a filtration system obtained from Millipore Corporation (Billerica, Mass.), on a video contact angle analyzer available as product number VCA-2500XE from AST Products (Billerica, Mass.). Reported values are the averages of measurements on at least three drops measured on the right and the left sides of the drops, and are shown in Table 2. Drop volumes were 5 μL for static measurements and 1-3 μL for advancing and receding. For hexadecane, only advancing and receding contact angles are reported because static and advancing values were found to be nearly equal.
2. Durability Test—The abrasion resistance of the cured films was tested cross-web to the coating direction by use of a mechanical device capable of oscillating cheesecloth or steel wool fastened to a stylus (by means of a rubber gasket) across the film's surface. The stylus oscillated over a 10 cm wide sweep width at a rate of 3.5 wipes/second wherein a “wipe” is defined as a single travel of 10 cm. The stylus had a flat, cylindrical geometry with a diameter of 1.25 inch (3.2 cm) for cheesecloth and a 6 mm diameter for steel wool. The device was equipped with a platform on which weights were placed to increase the force exerted by the stylus normal to the film's surface. The cheesecloth was obtained from Summers Optical, EMS Packaging, A subdivision of EMS Acquisition Corp., Hatsfield, Pa. under the trade designation “Mil Spec CCC-c-440 Product # S12905”. The cheesecloth was folded into 12 layers. The steel wool was obtained from Rhodes-American a division of Homax Products, Bellingham, Wash. under the trade designation “#0000-Super-Fine” and was used as received. A single sample was tested for each example, with the weight in grams applied to the stylus and the number of wipes employed during testing reported in Tables 3 and 4.
3. Bead-Up—An ink marking was applied to the surface layer with a pen commercially available under the trade designation “Sanford Sharpie, Fine Point permanent marker, no 30001”. Observations were made to determine whether the ink mark beaded up when applied to the surface (i.e. “yes” per Table 3 and 4) or did not bead up (i.e. “no” per Table 3 and 4).
4. Ink Repellency—An ink marking was applied to the surface layer with a pen commercially available under the trade designation “Sanford Sharpie, Fine Point permanent marker, no 30001”. Observations were made to determine whether the ink mark was easily removed by wiping with a dry tissue such as commercially available from Kimberly Clark Corporation, Roswell, Ga. under the trade designation “SURPASS FACIAL TISSUE”. (i.e. “yes” per Table 3 and 4) or did not bead up (i.e. “no” per Table 3 and 4).
5. King Marker Resistance Test—The tip of a KING SIZE permanent black marker was cut with a razor blade at an angle to allow for a wide marking width. Using a ruler, a straight line was drawn on the test sample using the marking at a speed of approximately 6 inches per second. The marked sample was then placed next to a 1-5 rating standard with 1 being the lightest and 5 being the darkest. The process was repeated three times and the average of the three tests was taken.
6. Haze and Transmission values of the coated films were measured by use of BYK Gardner Haze-Clarity-Transmission meter. The values are reported as percent.
   Ingredients

As used in the examples, “HFPO-” refers to the end group wherein a averages about 6.3.

F(CF(CF₃)CF₂O)ₐCF(CF₃)COOCH₃ wherein a averages about 6.3, with an average molecular weight of 1,211 g/mol, and which can be prepared according to the method reported in U.S. Pat. No. 3,250,808 (Moore et al.), the disclosure of which is incorporated herein by reference, with purification by fractional distillation.

F(CF(CF₃)CF₂O)ₐCF(CF₃)C(O)F of a molecular weight of about 1115 can be prepared according to the method reported in U.S. Pat. No. 3,250,808 (Moore et al), with purification by fractional distillation

Trimethylolpropane triacrylate (“TMPTA”) was obtained from Sartomer Company, Exton, Pa. under the trade designation “SR351” (AC-1)

Pentaerythritol tetraacrylate was obtained from Sartomer Company under the trade designation “SR295”. (AC-2)

Triethyleneglycol diacrylate was obtained from Sartomer Company under the trade designation “SR306”. (AC-3)

The amines: triethylamine, diisopropylethyl amine, 2-amino-2-ethyl-1,3-propane diol, 2-amino-2-methyl-1,3-propane diol, and 2-amino-1,3-propane diol, 2-aminoethanol, 2-(2-aminoethylamino)ethanol, and 3-amino-1,2-propanediol were obtained from Sigma-Aldrich, Milwaukee, Wis.

Acryloyl chloride was obtained from Sigma-Aldrich.

ω-hydro 2,2,3,3,4,4,5,5-octafluoropentyl acrylate (H—C₄F₈—CH₂O—C(O)—CH═CH₂) was obtained from Oakwood Products, West Columbia, S.C. (MP-2)

The UV photoinitiator used was obtained from Ciba Specialty Products, Terrytown, N.Y. under the trade designation “Darocur 1173”.

Preparation of HFPO—C(O)—NH—CH₂CH₂—OH Starting Material (i.e. HFPO-AE-OH)

50.0 g of the HFPO—C(O)OCH₃ (i.e. Mw=1211 g/mole) was placed in 200 ml round bottom flask. The flask was purged with nitrogen and placed in a water bath to maintain a temperature of 50° C. or less. To this flask was added 3.0 g (0.045 mol) of 2-aminoethanol. The reaction mixture was stirred for about 1 hr, after which time an infrared spectrum of the reaction mixture showed complete loss of the methyl ester band at 1790 cm⁻¹ and the presence of the strong amide carbonyl stretch at 1710 cm⁻¹. 200 ml of methyl t-butyl ether (MTBE) was added to the reaction mixture and the organic phase was extracted twice with water/HCl (˜5%) to remove unreacted amine and methanol. The MTBE layer was dried with MgSO₄. The MTBE was removed under reduced pressure to yield a clear, viscous liquid. ¹H Nuclear magnetic resonance spectroscopy (NMR) and infrared spectroscopy (IR) confirmed the formation of the above-identified compound.

Preparation of Monofunctional Perfluoropolyether Acrylate (MP-1)

HFPO—C(O)N(H)CH₂CH₂OC(O)CH═CH₂ (HFPO-AEA)

HFPO-AE-OH (600 g) was combined with ethyl acetate (600 g) and triethylamine (57.9 g) in a 3-neck round bottom flask that was fitted with a mechanical stirrer, a reflux condenser, addition funnel, and a hose adapter that was connected to a source of nitrogen gas. The mixture was stirred under a nitrogen atmosphere and was heated to 40° C. Acryloyl chloride (51.75 g obtained from Aldrich Chemical) was added dropwise to the flask from the addition funnel over about 30 minutes. The mixture was stirred at 40° C. overnight. The mixture was then allowed to cool to room temperature, diluted with 300 mL of 2N aqueous HCl and transferred to a separatory funnel. The aqueous layer was removed and the ethyl acetate layer was extracted with another 300 ml portion of 2N HCl. The organic phase was then extracted once with 5 wt-% aqueous NaHCO₃ separated, dried over MgSO₄ and filtered. Removal of the volatile components using a rotary evaporator resulted in 596 g of product (93% yield). ¹H NMR and IR spectroscopy confirmed the formation of the above-identified compound.

Synthesis of Perfluoropolyether Polyacrylate Compounds

1. Preparation of HFPO—C(O)N(H)C(CH₂OH)₂CH₂CH₃ Starting Material

To a 500 ml 3 necked flask equipped with a stir bar and reflux condenser was charged 11.91 g (0.1 mol) H₂NC(CH₂OH)₂CH₂CH₃ and 60 g THF. Next via dropping funnel was added 121.1 g (0.1 mol) HFPO—C(O)OCH₃ over about 80 min at a bath temperature of about 85° C. The reaction was cloudy at first, but became clear about 1 h into the reaction. After addition was complete, the heating bath was shut off and the reaction was allowed to cool over the weekend. The material was concentrated at 55° C. under aspirator vacuum to yield 130.03 g of a light colored syrup. NMR analysis showed the product to be an 87:13 mixture of the structures I to II as follows: 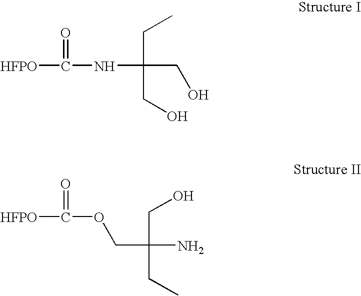
Preparation of Polyfunctional Perfluoropolyether Acrylate
HFPO—C(O)N(H)C(CH₂OC(O)CH═CH₂)₂CH₂CH₃ (FC-1)

To a 250 ml 3 necked round bottom flask equipped with overhead stirrer was charged 65 g (0.05 mol) of HFPO—C(O)N(H)C(CH₂OH)₂CH₂CH₃, the product mixture generated above, 12.65 g (0.125 mol) triethylamine and 65 g ethyl acetate. To the flask at room temperature was added 11.31 g(0.125 mol) acryloyl chloride using a pressure-equalizing dropping funnel over 12 min, with the reaction temperature rising from 25 to a maximum of 40° C. The dropping funnel was rinsed with 5 g additional ethyl acetate that was added to the reaction that was then placed in a 40° C. bath and allowed to react for 2 hours and 10 min additional time. The organic layer was then successively washed with 65 g 2% aqueous sulfuric acid, 65 g 2% aqueous sodium bicarbonate, and 65 g water, dried over anhydrous magnesium sulfate, filtered, treated with 16 mg methoxyhydroquinone (MEHQ), and concentrated on a rotary evaporator at 45° C. to yield 62.8 g of crude product. Next 35 g of this material was chromatographed on 600 ml of silica gel (SX0143U-3, Grade 62, 60-200 mesh, EM Science) using 25:75 ethyl acetate: heptane as an eluent. The first two fractions were 250 ml in volume, the remaining fractions were 125 ml in volume. Fractions 4-10 were combined, 8 mg MEHQ was added to the fractions, which were concentrated on a rotary evaporator at 55C to provide 25.36 g of product that was analyzed by NMR, and found to be an 88:12 mixture of the structures III to IV. 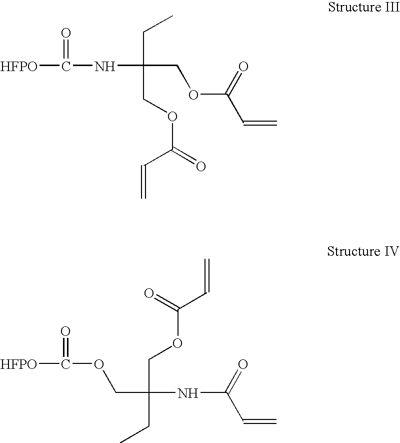
2. Preparation of HFPO—C(O)N(H)C(CH₂OH)₂H Starting Material

By a method similar to the preparation of HFPO—C(O)N(H)C(CH₂OH)₂CH₂CH₃, 106.74 g (0.088 mol) HFPO—C(O)CH₃ was reacted with 8.03 g (0.088 mol) 2-amino-1,3-propanediol in 51 g THF to provide a product that was 93:7 amide diol: ester amino-alcohol.

Preparation of Polyfunctional Perfluoropolyether Acrylate

HFPO—C(O)N(H)C(CH₂OC(O)CH═CH₂)₂H(FC-2)

In a method similar to the preparation of HFPO—C(O)N(H)C(CH₂OC(O)CH═CH₂)₂CH₂CH₃, 50 g (0.3936 mol) HFPO—C(O)N(H)C(CH₂OH)₂H Starting Material was reacted with 8.55 g (0.0945 mol) acryloyl chloride and 9.56 g (0.946 mol) triethylamine in 100 g of ethyl acetate, to provide after workup and chromatography, the 93:7 mixture of diacrylate and acrylamide-acrylate.

3. Preparation of HFPO—C(O)N(H)CH₂CH₂NHCH₂CH₂OH Starting Material

A 100 ml round bottom flask was charged with 50.0 g (0.413 mol) HFPO—C(O)OCH₃ and heated to 40C in an oil bath. The flask was removed from the bath and 4.30 (0.413 mol) 2-(2-aminoethylamino)ethanol was charged to the flask. The contents were swirled together and heated with stirring at 65° C. in an oil bath for 3 h, then concentrated at 65° C. on a rotary evaporator under aspirator pressure to provide the product.

Preparation of Polyfunctional Perfluoropolyether Acrylate

HFPO—C(O)N(H)CH₂CH₂N(C(O)CH═CH₂)CH₂CH₂OC(O)CH═CH₂ (FC-3)

In a method similar to the preparation of HFPO—C(O)N(H)C(CH₂OC(O)CH═CH₂)₂CH₂CH₃, 64.15 g (0.050 mol) HFPO—C(O)N(H)CH2CHNHCH2CH₂OH was reacted with 11.26 g (0.125 mol) acryloyl chloride and 12.65 g (0.125 mol) triethylamine in 65 g of ethyl acetate, to provide after workup and chromatography, the desired product.

4. Preparation of HFPO—C(O)N(H)CH₂CH(OH)CH₂OH Starting Material

By a method similar to the preparation of HFPO—C(O)N(H)C(CH₂OH)₂CH₂CH₃, 121.1 g (0.100 mol) HFPO—C(O)CH₃ was reacted with 9.11 g (0.100 mol) 1-amino-2,3-propanediol in 55.7 g THF to provide a product that was 86:14 amide diol: ester amino-alcohol.

Preparation of Polyfunctional Perfluoropolyether Acrylate (FC-4)

HFPO—C(O)N(H)CH₂CH(OC(O)CH═CH₂)CH₂OC(O)CH═CH₂

In a method similar to the preparation of HFPO—C(O)N(H)C(CH₂OC(O)CH═CH₂)₂CH₂CH₃, 63.5 g (0.050 mol) HFPO—C(O)N(H)CH₂CH(OH)CH₂OH was reacted with 11.26 g (0.0945 mol) acryloyl chloride and 9.56 g (0.946 mol) triethylamine in 100 g of ethyl acetate, to provide after workup and chromatography, the 86:14 mixture of diacrylate and acrylamide-acrylate.

5. Preparation of HFPO—C(O)—NH—C(CH₃)(CH₂—OH)₂ Starting Material

2-amino-2-methyl 1,3-propane diol (2.8 g, 0.027 mol, commercially available from Aldrich) was charged to a 200 ml round bottom flask and purged with nitrogen. The amine was dissolved in 40 g of 3:1 by weight mixture of methyl t-butyl ether and methanol and heated to reflux. After the amine was dissolved fully, oligomeric HFPO methyl ester (HFPO—C(O)OCH₃, 25.0 g, 0.021 mol, Mw=1211 g/mole) was added to the solution and the reaction was allowed to progress for approximately 24 hrs. The reaction mixture was analyzed by IR spectroscopy. The spectrum showed the presence of an amide signal at 1717 cm⁻¹ and the absence of the methyl ester signal at 1790 cm⁻¹. The reaction mixture was worked up by the addition of 250 ml of water/HCl (15 wt %), followed by extraction and further addition of methyl T-butyl ether. CaCl₂ was used to enhance the phase split between the organic and aqueous phases. The MTBE layers were combined and dried with MgSO₄. The MTBE was removed under reduced pressure to yield a clear, viscous liquid. Further drying at 0.1 mmHg and RT for 16 hrs, resulted in 23.1 g (85% yield). ¹H NMR and IR spectroscopy confirmed the formation of the above-identified compound.

Preparation of Polyfunctional Perfluoropolyether Acrylate

HFPO—C(O)N(H)C(CH₂OC(O)CH═CH₂)₂CH₃ (FC-5)

To a 100 ml 3 necked round bottom flask equipped with magnetic stir bar, thermometer, condenser and addition funnel was charged 15 g (0.011 mol) of HFPO—C(O)N(H)C(CH₂OH)₂CH₃, the product mixture generated above, 2.97 g (0.023 mol) N,N-diisopropylethylamine and 25 g ethyl acetate. The flask was heated to 40° C. To the flask was added 2.08 g (0.023 mol) acryloyl chloride dropwise over about 10 minutes. The dropping funnel was rinsed with 5 g additional ethyl acetate that was added to the reaction. The reaction was allowed to run overnight at 40° C. The organic layer was then cooled and successively washed twice with 25 g 2N hydrochloric acid, twice with 25 g 5% aqueous sodium bicarbonate, and 25 g water, dried over anhydrous magnesium sulfate, filtered and dried on a rotary evaporator at 50° C. to yield 10.14 g product.

6. Preparation of HFPO—C(O)NH(C₂H₄NH)₅C(O)—HFPO:

In a sealed 120 mL Pyrex tube, 20 g of HFPO—CO₂Me (20 mmol) was mixed with 2.32 g NH₂(C₂H₄NH)₅H (10 mmol), and reacted at 110° C. for 4 hours with magnetic stirring. In less than 20 minutes, the mixture was turned into a clear homogenous solution. The solution was allowed to react for 5 hours. From FTIR analysis, the signal at 1787 cm⁻¹ (—CO₂Me) was disappeared, and showed the corresponding amide linkage at 1718 cm⁻¹. After methanol strip under full vacuum, gave the corresponding perfluoroether amine oligomer with MW ˜2626.38.
7. Preparation of HFPO—C(O)NH(C₂H₄NH)₅C(O)—HFPO/IEM in 1/2 ratio: 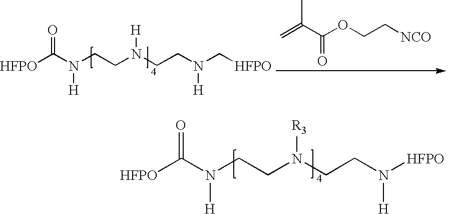
R₃ is independently H or CH₂═C(CH₃)C(O)—OC₂H₄NHC(O)— in 1/1 ratio

In a 100 mL flask, charged with 5.96 g HFPO—C(O)NH(C₂H₄NH)₅—C(O)—HFPO (2.27 mmol), 5.0 g HFE-7100 and 15 g EtOAc. To above clear solution, added 0.73 g (4.7 mmol) IEM in 5 g EtOAc at room temperature. An exothermic reaction started, and the solution turned into cloudy. After continued reaction for 0.5 hour, the solvent was stripped, and the residue was dissolved in acetone. From NMR, 1714.16 cm⁻¹ and 1637.20 cm⁻¹ were observed for the corresponding —CONH— and CH₂═CMe-, but no —NCO signal.
8. Preparation of HFPO—C(O)NH(C₂H₄NH)₅C(O)—HFPO/Glycidyl methacrylate in 1/4 ratio:

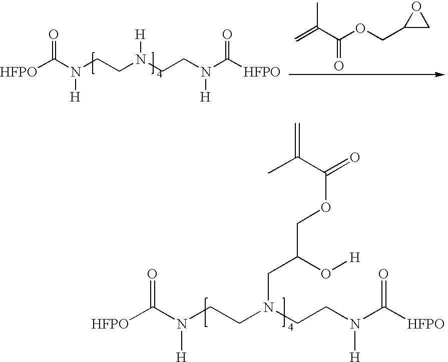

In a 100 mL flask, charged with 13.43 g HFPO—C(O)NH(C₂H₄NH)₅C(O)—HFPO (5.11 mmol). Glycidyl methacrylate (MW=142.15, 2.88 g, 20.26 mmol) was added, and the mixture was reacted at 70C for 2 hours to form a wax solid, which is soluble in IPA.

Preparation of the Coating Solutions:

Substrates were coated with polymerizable compositions using materials and amounts by weight as reported in Table 1. All polymerizable components were diluted to 10 percent by weight total solids in methyl ethyl ketone. Two percent by weight of photoinitiators PI-1 was included in the polymerizable compositions using a 10 percent solids photoinitiator solutions in methyl ethyl ketone. The photoinitiator was added before dilution to the final percent by weight total solids. Dilution to the final percent by weight total solids was achieved using methyl isobutyl ketone

Coating, Drying, Curing Process

Two different substrates, each having a hardcoat surface layer were used in the Examples. The first substrate (S-1) was prepared from a transparent polyethylene terephthalate (PET) film obtained from e.i. DuPont de Nemours and Company, Wilmington, Del. under the trade designation “Melinex 618” having a thickness of 5.0 mils and a primed surface. A hardcoat composition that was substantially the same as Example 3 of U.S. Pat. No. 6,299,799 was coated onto the primed surface and cured in a UV chamber having less than 50 parts per million (ppm) oxygen. The UV chamber was equipped with a 600 watt H-type bulb from Fusion UV systems, Gaithersburg Md., operating at full power. The second substrate (S-2) was a matte film having a preapplied hardcoat surface layer commercially available from U.S.A. Kimoto Tech, Cedartown, Ga. under the trade designation “N4D2A” (S-2). The matte film was used without further modification.

The hardcoat was applied to the Melinex 618 film with a metered, precision die coating process. The hardcoat was diluted in IPA to 30 wt-% solids and coated onto the 5-mil PET backing to achieve a dry thickness of 5 microns. A flow meter was used to monitor and set the flow rate of the material from a pressurized container. The flow rate was adjusted by changing the air pressure inside the sealed container which forces liquid out through a tube, through a filter, the flow meter and then through the die. The dried and cured film was wound on a take up roll and used as the input backing for the coating solutions described below.

The hardcoat coating and drying parameters for S-1 were as follows:
Coating width: 6″ (15 cm)
Web Speed: 30 feet (9.1 m) per minute
Solution % Solids: 30.2%
Filter: 2.5 micron absolute
Pressure Pot: 1.5 gallon capacity (5.71)
Flow rate: 35 g/min
Wet Coating Thickness: 24.9 microns
Dry Coating Thickness: 4.9 microns
Conventional Oven Temps:
   140° F. (60° C.) Zone 1
   160° F. (53° C.) Zone 2
   180° F. (82° C.) Zone 3
Length of oven 10 feet (3 m)

The coating compositions of the invention were coated onto the hardcoat layer of either S-1 or S-2 using a precision, metered die coater. For this step, a syringe pump was used to meter the solution into the die. The solutions were diluted to a concentration of 2-2.5% methylethyl ketone and coated onto the hardcoat layer to achieve a dry thickness of 40-60 nm. The material was dried in a conventional air flotation oven and then sent through the UV chamber having less than 50 ppm oxygen. The UV chamber was equipped with a 600 watt H-type bulb from Fusion UV systems, Gaithersburg Md., operating at full power.

The surface layer coating and drying parameters were as follows:
Coating width: 4″ (10 cm)
Web Speed: 10 feet per minute
Solution % Solids: 2.0-2.5%
Pump: 60 cc Syringe Pump
Flow rate: 1.2 cc/min
Wet Coating Thickness: 4.1 microns
Dry Coating Thickness: 60 nm
Conventional Oven Temps:
   65° C. Zone 1
   65° C. Zone 2

Length of oven 10 feet (3 m)

TABLE 1
Coating Formulations

| Example | (AC-1) | (MP-1) | (FC-1) | (FC-2) | Other | Substrate |
|---|---|---|---|---|---|---|
| 9a | 95 | | 5 | | | S-1 |
| 9b | 95 | | 5 | | | S-2 |
| 10b | 20 | 70 | 10 | | | S-2 |
| 11b | 20 | 10 | 70 | | | S-2 |
| 12a | 95 | | | 5 | | S-1 |
| 12b | 95 | | | 5 | | S-2 |
| 13a | 97.5 | | 2.5 | | | S-2 |
| 14a | 98.75 | | 1.25 | | | S-2 |
| 15b | 95 | | 5 | | 95 (AC-2) | S-2 |
| 16b | 95 | | 5 | | | S-2 |
| 17a | 90 | | 5 | | 5 (MP-2) | S-1 |
| 19a | 85 | | 5 | | 10 (FC-3) | S-1 |
| 20a | 95 | | | | 5 FC-3 | S-1 |
| A | 95 | | | | 5 FC-4 | S-1 |
| Compar- | 100 | | | | | |
| ative A | | | | | | |
| Compar- | 100 | | | | | |
| ative B | | | | | | |

TABLE 2
Test Results

| | Contact angle | | | Contact Angle | | Haze | Trans |
|---|---|---|---|---|---|---|---|
| | with water | | | with Hexadecane | | before | before |
| Example | Static | Advancing | Receding | Advancing | Receding | testing | testing |
| 9a | 108 | 118 | 97 | 65 | 59 | 0.54 | 95 |
| 10b | 110 | 123 | 89 | 70 | 60 | NM | NM |
| 11b | 110 | 123 | 89 | 69 | 59 | NM | NM |
| 12a | 106 | 119 | 96 | 65 | 57 | 0.46 | 94 |
| 13a | 94 | 109 | 85 | 52 | 44 | 0.52 | 93.4 |
| 14a | 55 | 73 | 42 | NM | NM | 0.23 | 93.1 |
| 15b | 105 | 119 | 94 | 66 | 59 | NM | NM |
| 16b | 108 | 121 | 86 | 67 | 59 | NM | NM |
| 17a | 104 | 118 | 89 | 65 | 56 | 0.37 | 92.5 |
| 18a | 108 | 119 | 98 | 66 | 56 | 0.37 | 91.9 |
| 19a | 107 | 120 | 97 | 67 | 56 | 0.37 | 92.1 |
| 20a | 107 | 120 | 95 | 68 | 57 | 0.39 | 92.2 |
| Comparative | 59 | 76 | 47 | 18 | NM | NM | NM |
| A | | | | | | | |

NM—(Not Measured)

TABLE 3
Cheesecloth Durability Test Results

| | | | Before cheesecloth | | After | |
|---|---|---|---|---|---|---|
| | | | rubs | | Cheesecloth rubs | |
| Ex- | Wt, in g | | Ink re- | Ink | Ink | Ink |
| am- | Applied | No. of | pellency | Beads Up | repellency | Beads Up |
| ple | to Stylus | Cycles | Yes/No | Yes/No | Yes/No | Yes/No |
| 16b | 725 | 200 | Y | Y | Y | Y |
| 12b | 725 | 200 | Y | Y | Y | Y |
| Com- | 725 | 200 | N | N | N | N |
| par- | | | | | | |
| ative | | | | | | |
| B | | | | | | |

TABLE 4
Steel Wool Durability Test Results

| | | | Before Steel | | After Steel | |
|---|---|---|---|---|---|---|
| | Wt, in g | | Wool rubs | | Wool rubs | |
| Ex- | Applied | | Ink | Ink | Ink | Ink |
| am- | to | No. of | repellency | Beads Up | repellency | Beads Up |
| ple | Stylus | Cycles | Yes/No | Yes/No | Yes/No | Yes/No |
| 9a | 200 | 500 | Y | Y | Y | Y |
| 12a | 200 | 500 | Y | Y | Y | Y |
| 17a | 1000 | 750 | Y | Y | Y | Y |
| 18a | 1000 | 750 | Y | Y | Y | Y |
| 19a | 1000 | 500 | Y | Y | Y | Y |
| 20a | 1000 | 500 | Y | Y | Y | Y |
| Com- | 200 | 500 | N | N | N | N |
| par- | | | | | | |
| ative | | | | | | |
| B | | | | | | |

Hardcoat Compositions

In another example (Ex. 21), an embodied perfluoropolyether poly(meth)acryl compound was an ingredient of the hardcoat formulation. A curable liquid ceramer composition was prepared by dilution in a small glass vial of 0.02 g FC-5 with 25 g of a hardcoat composition that is substantially the same as Example 3 of U.S. Pat. No. 6,299,799 (“S-1”). The mixture was mixed well then diluted by weighing 1 gram of the fluorine-containing hardcoat formula into a vial and diluting with 7.0 g hardcoat. The resulting mixture was coated onto PET film using a #30 wire wound bar. The uncured mixture was dried at room temperature for 5 minutes, followed by 5 minutes at 60° C., then UV cured with one pass through the UV chamber.

Test Result:

The UV cured hardcoat containing the perfluoroether diacrylate showed ink repellency.

22. Preparation of

CH₂═CHCO(O)CH₂CH(OC(O)Rf)CH₂OCH₂CH(OR)CH₂OCH₂CH(OCORf)CH₂° C. (O)CH═CH₂ where Rf is HFPO MW1115 and the central OR is a mixture of OH and OCORf. (HFPO3-DGDA)

A mixture of 3.5 g (0.01 mol) glycerol 1,3-diglycerolate diacrylate (Aldrich), 4.0 g diisopropylethylamine, and 100 ml CH₂Cl₂ was treated with 35.5 g F(CF(CF₃)CF₂O)ₐCF(CF₃)C(O)F of a molecular weight of about 1115 and stirred as a heterogeneous mixture for 3 hr. The mixture was washed twice with about 50 ml water, dried over MgSO₄, and stripped to 29.3 g pale yellow oil, n_{D} 1.3553 (21.1C). 2D-nmr showed a complex mixture with about 2.9 HFPO chains per 2 acrylates, but some secondary OH was present as well as some COOH and some of the acrylates were secondary, instead of primary as the Aldrich structure is assigned.

23. A UV-curable hardcoat solution was prepared with 0.4 phr HFPO3-DGDA in a curable liquid ceramer composition. The ceramer hardcoat was prepared by adding 0.2078 grams of the fluorochemical modifier and 0.20 g H(CF₂)₄CH₂OH to 100 grams of 50% solids hardcoat composition that is substantially the same as Example 3 of U.S. Pat. No. 6,299,799 (“S-1”). The mixture was coated using a #8 wire wound onto a polyester film substrate commercially available from Mitsubishi under the trade designation “Hostaphan® 4507”. The coated film was air dried 5 minutes, followed by oven heating 5 minutes at 70° C., then UV curing with one pass through the processor.

Test Result:

A clear film was produced that exhibit ink repellency and wipes clean. Static water contact angle was 100 degrees, and static hexadecane contact angle was 65 degrees.

Coating on Vinyl Sheet

Preparation of HFPO dihydroalcohol, F-[CF(CF₃)CF₂O]ₐCF(CF₃)CH₂OH, a=5-7

A 3-L round bottom flask equipped with a mechanical stirrer and nitrogen bubbler was charged with 1 liter of glyme, sodium borohydride (85 g, 2.2 mol) and heated to 77° C. Oligomeric HFPO ester, F-[CF(CF₃)O]ₐCF(CF₃)COOCH₃, a=5-7 (810 g, 0.8 mol) prepared as described in U.S. Pat. No. 3,114,778 was added to the stirred slurry over one hour. An exotherm was observed and heated to 88° C. for 18 hours. Heat was removed and 300 g methanol was added over three hours with evolution of hydrogen. Reaction was quenched with a mixture of 290 g of concentrated sulfuric acid in 1 kg of water. Solvents were removed by heating to a final head temperature of 93° C. Fluorochemical lower phase was separated and vacuum heated to remove water. Oligomer HFPO dihydroalcohol, F-[CF(CF₃)O]ₐCF(CF₃)CH₂OH, a=5-7 (688 g, 0.7 mol) was made in an 88% yield and the structure was confirmed by FTIR and H and FNMR.

25. Preparation of Oligomeric HFPO dihydroglycidol diacrylate F-[CF(CF₃)CF₂O]ₐCF(CF₃)CH₂OCH₂CH(OC(O)CH═CH₂)CH₂OC(O)CH═CH₂, a=5-7

To a 500 ml 3-neck round bottom flask equipped with a mechanical stirrer and nitrogen bubbler was charged with oligomeric HFPO dihydroalcohol (200 g, 0.2 mol) made as just described and sodium methoxide 25% in methanol (43 g, 0.2 mol) and heated to 95° C. After one hour, methanol along with volatiles were stripped and cooled to 45° C. Glycidol (15 g, 0.2 mol) was added and the flask was heated to 100° C. for 18 hours. Reactor was cooled to 25° C. and 200 g CFCl₂CF₂Cl solvent was added along with 25 ml of a 10% sulfuric acid solution. Mixture was water washed and the fluorochemical phased was dried with MgSO₄, filtered and vacuum dried to yield oligomer HFPO dihydroglycidol (131 g, 0.62 mol) for a 62% yield and confirmed by H and FNMR. To a 250 ml round bottom flask equipped with mechanical stirrer and nitrogen bubbler was charged with oligomer HFPO dihydroglycidol (30 g, 0.2 mol), 50 g glyme and 5 g triethylamine. One phase was obtained by addition of 18 g CFCl₂CF₂Cl solvent and heated to 45° C. for thirty minutes. Addition of acryloyl chloride (4.6 g, 0.05 mol) over thirty minutes with an exotherm and precipitate formation. Added 63 g water and the lower fluorochemical phase was dried with MgSO₄, filtered and stripped dry under vacuum. A yield of 65% oligomeric HFPO dihydroglycidol diacrylate F-[CF(CF₃) CF₂O]ₐCF(CF₃)CF₂CH₂OCH₂CH(OC(O)CH═CH₂)CH₂OC(O)CH═CH₂, a=5-7 was confirmed by H and FNMR.

24 and 25. Preparation of Coating Composition

0.025 g of C₃F₇O—[CF(CF₃)CF₂O]ₐCF(CF₃)CH₂OCH₂CH(OC(O)CH═CH₂)CH₂OC(O)CH═CH₂, a=4-6 (prepared as just described) was added to 9.975 g of an aliphatic acrylate commercially available from Sartomer under the trade designation “Sartomer 306”. Example 25 was prepared in the same manner except that a 9:1 blend of “Sartomer 306 and “Sartomer 492” were employed. 0.05 g of “Darocur 1173” photoinitiator was added to each of Examples 24 and 25. The three materials were mixed together in a vial and placed on a shaker for 5 minutes before coating. Each sample was then coated onto a piece of white soft vinyl (4″×6″) obtained from Armstrong, Lancaster, Pa., Excelon. The samples were hand coated using # 10 Meyer bar then photo-polymerized using a PRC UV processor (Model # 84-502) at a line speed of 30 ft/min. This gave a shiny smooth hard coat.

The two treated vinyl samples were then tested for ink repellency and receding contact angle. Examples 24 and 25 had hexadecane receding contact angles of 62 and 48 respectively and the King Size Permanent Marker Resistance of both samples was “1”.

1. A fluoropolyether poly(meth)acryl compound comprising at least one terminal perfluoropolyether group and at least two groups (meth)acryl groups.

2. The fluoropolyether poly(meth)acryl compound of claim 1 wherein the perfluoropolyether group is F(CF(CF₃)CF₂O)ₐCF(CF₃)— wherein a averages 1 to 15.

3. A fluoropolyether poly(meth)acryl compound of claim 2 wherein a averages between 3 and 10.

4. The fluoropolyether poly(meth)acryl compound of claim 2 wherein a averages 5 to 8.

5. The fluoropolyether poly(meth)acryl compound of claim 1 wherein the (meth)acryl groups are independently selected from methacrylate groups and acrylate groups.

6. The fluoropolyether poly(meth)acryl compound of claim 1 wherein the compound is of the formula (R_{fpe})ₙQ(X)ₘ wherein:
R_{fpe} is the residue of a monovalent HFPO moiety of the formula F(CF(CF₃)CF₂O)ₐCF(CF₃)— where a is 3 to 15 and n is 1 to 3;
Q is a connecting group of valency at least 2 and is selected from the group consisting of a covalent bond, an alkylene, an arylene, an aralkylene, an alkarylene, a straight or branched chain or cycle-containing connecting group optionally containing heteroatoms O, N, and S and optionally a heteroatom-containing functional group such as carbonyl or sulfonyl, and combinations thereof;
X is a (meth)acryl functional group -AC(O)C(R)=CH₂, where A is O, S or NR₁, R is a lower alkyl of 1 to 4 carbon atoms or H or F, R₁ is H or lower alkyl of 1 to 4 carbon atoms, and m is 2-10.

7. The fluoropolyether poly(meth)acryl compound of claim 1 wherein the compound is of the formula B—O(CH₂CH(OB)CH₂O)ₙCH₂CH(OB)CH₂O—B wherein n ranges from 0 to 20, and B is independently H, —C(O)CH═CH₂, or —C(O)—HFPO, and in which at least one B is —C(O)—HFPO and at least two B are —C(O)CH═CH₂.

8. The fluoropolyether poly(meth)acryl compound of claim 1 wherein the compound is reaction product of the reaction 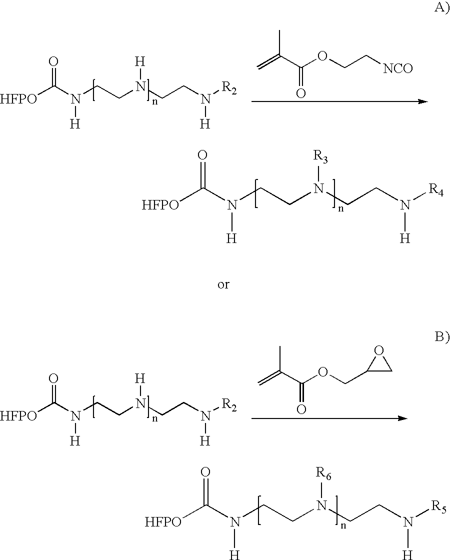
wherein
R₂ is hydrogen, alkyl, aryl, arylalkyl, alkylaryl, fluoroalkyl, acryl, HFPO—C(O)—,
R₃ is independently H or CH₂═C(CH₃)C(O)—OC₂H₄NHC(O)—,
R₄ is alkyl, aryl, arylalkyl, alkylaryl, fluoroalkyl, acryl, HFPO—C(O)—, or
CH₂═C(CH₃)C(O)—OC₂H₄NHC(O)—,
R₅ is alkyl, aryl, arylalkyl, alkylaryl, fluoroalkyl, acryl, HFPO—C(O)—, or
CH₂═C(CH₃)C(O)—OCH₂CH(OH)CH₂—,
R₆ is independently H or CH₂═C(CH₃)C(O)—OCH₂CH(OH)CH₂—,
and n ranges from an average about 2 to 32.

9. The fluoropolyether poly(meth)acryl compound of claim 1 wherein the compound is selected from the group consisting of
a) HFPO—C(O)NHC(CH₂OC(O)CH═CH₂)₃;
b) HFPO—C(O)N(CH₂CH₂OC(O)CH═CH₂)₂;
c) HFPO—C(O)NHCH₂CH₂N(C(O)CH═CH₂)CH₂OC(O)CH═CH₂;
d) HFPO—C(O)NHC(CH₂OC(O)CH═CH₂)₂H;
e) HFPO—C(O)NHC(CH₂OC(O)CH═CH₂)₂CH₃;
f) HFPO—C(O)NH(CH₂OC(O)CH═CH₂)₂CH₂CH₃;
g) HFPO—C(O)NHCH₂CH(OC(O)CH═CH₂)CH₂OC(O)CH═CH₂;
h) HFPO—C(O)NHCH₂CH₂CH₂N(CH₂CH₂OC(O)CH═CH₂)₂;
i) HFPO—C(O)OCH₂C(CH₂OC(O)CH═CH₂)₃;
j) HFPO—C(O)NH(CH₂CH₂N(C(O)CH═CH₂))₄CH₂CH₂NC(O)—HFPO;
k) CH₂═CHC(O)OCH₂CH(OC(O)HFPO)CH₂OCH₂CH(OH)CH₂OCH₂CH(OC(O)HFPO)CH₂OCOCH═CH₂; and
l) HFPO—CH₂O—CH₂CH(OC(O)CH═CH₂)CH₂OC(O)CH═CH₂.

10. An article comprising a substrate and a surface layer comprising the fluoropolyether poly(meth)acryl compound of claim 1.

11. The article of claim 10 wherein the surface layer comprises the reaction product of a polymerizable composition comprising the fluoropolyether poly(meth)acryl compound of claim 1.

12. A coating composition comprising at least one fluoropolyether poly(meth)acryl compound of claim 1 and a diluent selected from solvent, (meth)acryl monomer, and mixtures thereof.

13. The coating composition of claim 12 wherein the amount of fluoropolyether poly(meth)acryl compound ranges from to 0.05 wt-% solids to 15 wt-% solids.

14. The coating composition of claim 12 wherein the solvent is selected from non-fluorinated organic solvents, fluorinated organic solvents, and mixtures thereof.

15. The coating composition of claim 12 wherein the composition further comprises a second fluorinated compound.

16. The coating composition of claim 15 wherein the second fluorinated compound is a fluoropolyether acrylate.

17. The coating composition of claim 12 further comprising a poly(meth)acryl crosslinking agent.

18. The coating composition of claim 17 wherein the crosslinking agent is non-fluorinated.

19. The coating composition of claim 11 wherein the dried and optionally cured coating composition exhibits ink repellency.

20. A ceramer comprising a binder, inorganic particles, and the fluoropolyether poly(meth)acryl compound of claim 1.
